(19) United States
(12) Patent Application Publication
(10) Pub. No.: US 2009/0279502 A1
(43) Pub. Date: Nov. 12, 2009

(54) INTERNETWORKING BETWEEN WMAN AND WLAN NETWORKS

(75) Inventors: Haihong Zheng, Coppell, TX (US); Shashikant Maheshwari, Irving, TX (US); Yousuf Saifullah, Richardson, TX (US); Srinivas Sreemanthula, Flower Mound, TX (US)

Correspondence Address: BRAKE HUGHES BELLERMANN LLP, c/o CPA Global, P.O. BOX 52050, MINNEAPOLIS, MN, 55402, US

(73) Assignees: NOKIA CORPORATION, Espoo (FI); NOKIA SIEMENS NETWORKS OY, Espoo (FI)

(21) Appl. No.: 12/118,448

(22) Filed: May 9, 2008

(51) Int. Cl. H04Q 7/00

(52) U.S. Cl. 370/331

(57) ABSTRACT

According to one general aspect, a method of using a base station (BS) comprising receiving, by the BS of a first wireless network, a notification that a mobile station (MS) is entering a semi-idle state with respect to the first network, wherein the semi-idle mode is also associated with the MS performing a handover from a first wireless network based upon a first networking standard to a second wireless network based upon a second networking standard. Further comprising storing a portion of a set of context information associated with the MS. Also comprising allocating uplink resources for the MS only to receive location update messages from the MS. And, maintaining at least some of the context information of the MS.

### TECHNICAL FIELD

This description relates to wireless networks.

### BACKGROUND

Typically, wireless networks include a base station that generally couples a wired network with a wireless network and mobile station that uses the wireless network. Often these two devices are in direct communication. However, multiple wireless network standards are in use or development. Due to the ranged nature of wireless networks, it is possible that a mobile station may be connected to or in the range of a number of wireless networks.

Worldwide Interoperability for Microwave Access (WiMAX) is a telecommunications technology often aimed at providing wireless data over long distances (e.g., kilometers) in a variety of ways, from point-to-point links to full mobile cellular type access. A network based upon WiMAX is occasionally also called a Wireless Metropolitan Access Network (WirelessMAN or WMAN); although, it is understood that WMANs may include protocols other than WiMAX. WiMAX often includes a network that is substantially in compliance with the IEEE 802.16 standards, their derivatives, or predecessors (hereafter, “the 802.16 standard”). Institute of Electrical and Electronics Engineers, IEEE Standard for Local and Metropolitan Area Networks, Part 16, IEEE Std. 802.16-2004.

Wireless Local Area Network (WLAN) is a telecommunications technology often aimed at providing wireless data over shorter distances (e.g., meters or tens of meters) in a variety of ways, from point-to-point links to full mobile cellular type access. A network based upon the WLAN standard is occasionally also referred to by the common or marketing name “WiFi” (or “Wi-Fi”) from Wireless Fidelity; although it is understood that WLAN may include other shorter ranged technologies. WiFi often includes a network that is substantially in compliance with the IEEE 802.11 standards, their derivatives, or predecessors (hereafter, “the 802.11 standard”). Institute of Electrical and Electronics Engineers, IEEE Standard for Information Technology—Telecommunications and Information Exchange between Systems—Local and Metropolitan Area Network—Specific Requirements—Part 11: Wireless LAN Medium Access Control (MAC) and Physical Layer (PHY) Specifications, IEEE Std. 802.11-2007.

### SUMMARY

According to one general aspect, a method of using a base station (BS) that is part of a first wireless network comprising receiving a notification that a mobile station (MS) is entering a semi-idle state with respect to the first network, wherein the semi-idle mode is also associated with the MS performing a handover from a first wireless network based upon a first networking standard to a second wireless network based upon a second networking standard. Further comprising storing a portion of a set of context information associated with the MS. Also comprising allocating uplink resources in the first wireless network for the MS to send location update messages from the MS while staying in the second wireless network. And, maintaining at least some of the context information of the MS.

According to one general aspect, a method of using a mobile station (MS) comprising while the MS is associated with a serving base station (BS) of a network that uses a first wireless networking standard, detecting a target BS of a network that uses the first wireless networking standard. Further comprising sending a location update message to the target BS indicating that: the MS is currently engaged with a network that uses a second wireless networking standard, and the MS is requesting an association between the MS and the target BS. Wherein the location update message indicates that the target BS should retrieve a stored portion of a set of context information to allow the BS to perform a fast handover when a handover is requested by the MS.

According to one general aspect, a method of using a base station (BS) comprising receiving, by the base station (BS), a reentry request from a mobile station (MS) indicating that the MS is initiating a handover from a non-WiMAX network back to the WiMAX network. Further comprising retrieving a stored portion of the MS context information locally at the BS to allow the BS to perform a fast handover. Also comprising performing the fast handover of the MS from the non-WiMAX network to the WiMAX network.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of a wireless network in accordance with an example embodiment of the disclosed subject matter.

FIG. 2 is a block diagram of two wireless devices in accordance with an example embodiment of the disclosed subject matter.

FIG. 3 is a block diagram of a wireless system in accordance with an example embodiment of the disclosed subject matter.

FIG. 4 is a timing diagram of a wireless network in accordance with an example embodiment of the disclosed subject matter.

FIG. 5 is a timing diagram of a wireless network in accordance with an example embodiment of the disclosed subject matter.

FIG. 6 is a timing diagram of a wireless network in accordance with an example embodiment of the disclosed subject matter.

FIG. 7 is a timing diagram of a wireless network in accordance with an example embodiment of the disclosed subject matter.

FIG. 8 is a flowchart of a technique in accordance with an example embodiment of the disclosed subject matter.

FIG. 9 is a flowchart of a technique in accordance with an example embodiment of the disclosed subject matter.

FIG. 10 is a flowchart of a technique in accordance with an example embodiment of the disclosed subject matter.

### DETAILED DESCRIPTION

Referring to the Figures in which like numerals indicate like elements,

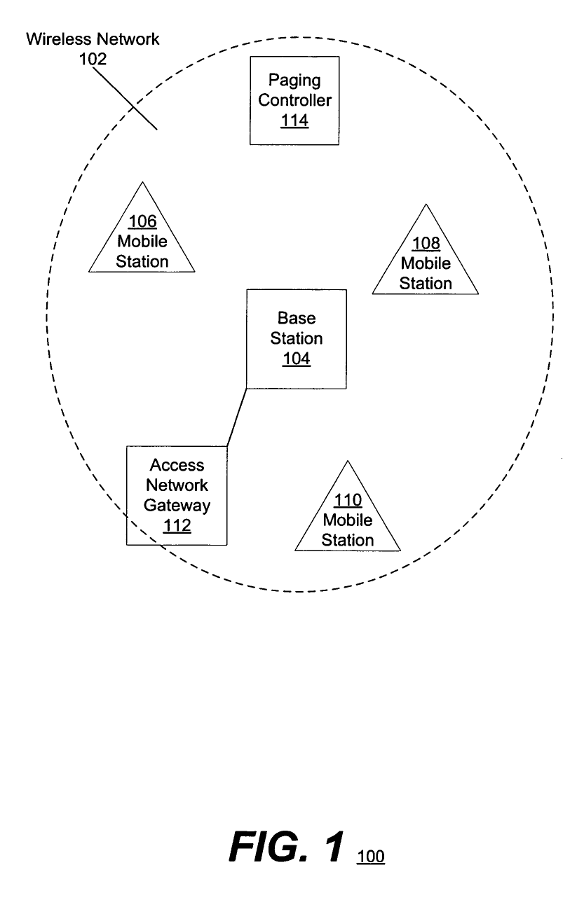

FIG. 1 is a block diagram of a wireless network 102 including a base station (BS) 104 and mobile stations (MSs) 106, 108, 110, according to an example embodiment. Each of the MSs 106, 108, 110 may be associated with BS 104, and may transmit data in an uplink direction to BS 104, and may receive data in a downlink direction from BS 104, for example. Although only one BS 104 and three mobile stations (MSs 106, 108 and 110) are shown, any number of base stations and mobile stations may be provided in network 102. Also, although not shown, mobile stations 106, 108 and 110 may be coupled to base station 104 via relay stations or relay nodes, for example. The base station 104 may be connected via wired or wireless links to another network (not shown), such as a Local Area Network, a Wide Area Network (WAN), the Internet, etc. In various embodiments, the base station 104 may be coupled or connected with the other network 120 via an access network controller (ASN) or gateway (GW) 112 that may control, monitor, or limit access to the other network.

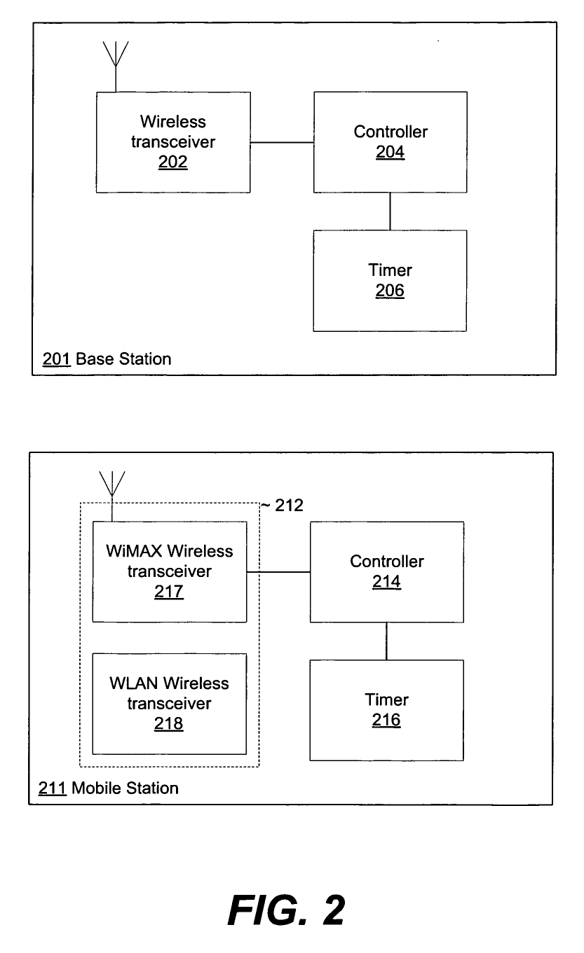

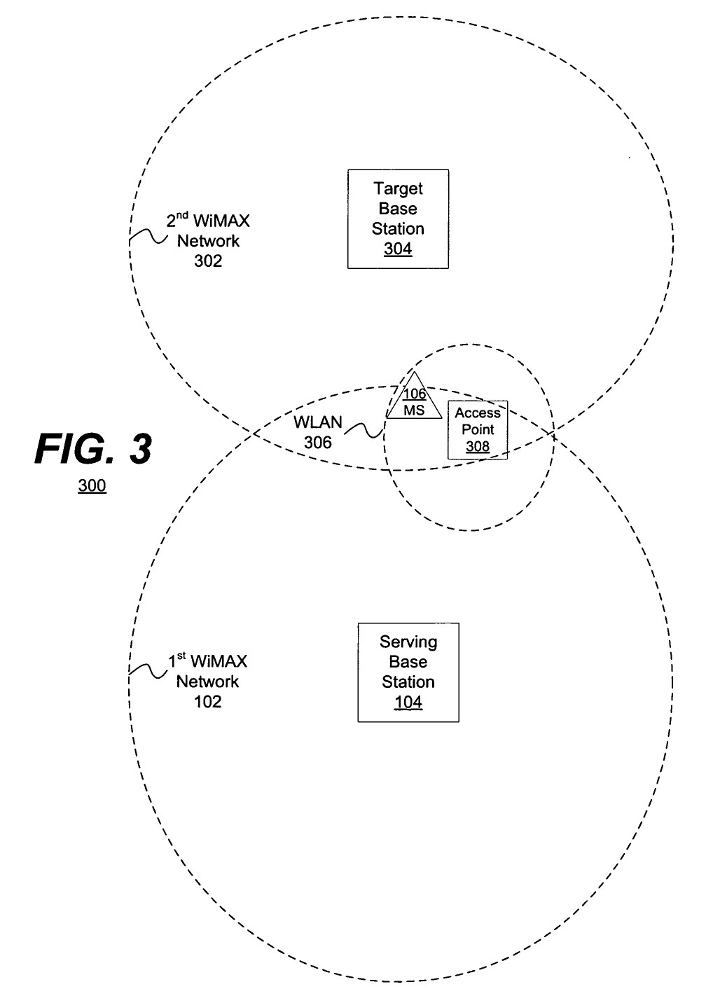

FIG. 2 is a block diagram of a wireless device 201 in accordance with an example embodiment of the disclosed subject matter. In one embodiment, the wireless device 201 may include a base station such as illustrated in FIG. 1. In another embodiment, the wireless device 201 may include a mobile station such as those illustrated in FIG. 1. In one embodiment, the wireless device 201 may include a wireless transceiver 202, a controller 204, and a timer 206. In various embodiments, the controller 204 may include a processor. For example, some operations illustrated and/or described herein, may be performed by a controller 204, under control of software or firmware.

FIG. 2 is also a block diagram of a wireless device 211 in accordance with an example embodiment of the disclosed subject matter. In one embodiment, the wireless device 211 may include a mobile station such as those illustrated in FIG. 1. In one embodiment, the wireless device 211 may include a wireless transceiver 212, a controller 214, and a timer 216. In some embodiments, the transceiver 212 may include a first wireless transceiver 217 configured to operate based upon a first wireless networking standard (e.g., WiMAX, in one embodiment). In some embodiments, the transceiver 212 may also include a second wireless transceiver 218 configured to operate based upon a second wireless networking standard (e.g., WLAN, in one embodiment). In various embodiments, the controller 214 may include a processor. For example, some operations illustrated and/or described herein, may be performed by a controller 214, under control of software or firmware.

FIG. 3 is a block diagram of a wireless system 300 in accordance with an example embodiment of the disclosed subject matter. In one embodiment, the system 300 may include a first network 102 based upon a first networking standard, a second network 302 based upon the first networking standard, and a third network 306 based upon a second wireless networking standard. In one embodiment, the first standard may include the WiMAX standard. In one embodiment, the second standard may include the WLAN standard.

In one embodiment, the system 300 may include a mobile station (MS) 106. In one embodiment, the MS 106 may be connected or associated with the first network 102 via the base station (BS) 104. The first network 102 may have a relatively large expected wireless signal range, such as greater than one kilometer.

In such an embodiment, as a larger network the first network 102 may encompass or substantially overlap with the third network (hereafter, “WLAN”) 306. The WLAN 306 may include a relatively short expected wireless signal range, such as less than one kilometer. In some embodiments, the expected range may be tens of meters (e.g., an expected indoor range of ˜40 meters for the IEEE 802.11g standard) or a few hundred meters (e.g., an expected outdoor range of ˜250 meters for IEEE 802.11n standard). It is understood that the above are merely a few illustrative examples to which the disclosed subject matter is not limited.

In such an embodiment, the MS 106 may be in range of both the first network 102 and the WLAN 306. In one embodiment, the MS 106 may decide to couple or connect with both networks. In another embodiment, the MS 106 may select which of the two networks to be actively coupled with.

In one embodiment, the MS 106 may be coupled with the first network 102 via the BS 104. In the same embodiment, the MS 106 may be coupled with the WLAN 306 via the access point (AP) 308. In one embodiment, the AP 308 may, like a BS, transmit data to and from the MS and be coupled via wired or wireless links to another network (not shown), such as a Local Area Network, a Wide Area Network (WAN), the Internet, etc. It is understood that, in various embodiments, as the AP 308 and BS 104 may operate using different networking standards and, therefore, their specific interactions with the MS 106 may differ.

In one embodiment, while the WiMAX network 102 may provide a larger radio coverage for mobile or nomadic users the WLAN 306 may provide better throughput. Therefore, in one embodiment, the MS 106 may prefer to use the WLAN 306 when it is within range; although the disclosed subject matter is not limited to any one motive. The process of switching or transferring from a first network or base station to another network or base station may be known as a “handover”.

In one embodiment, the MS 106 may perform a handover from the first WiMAX network 102 to the WLAN 306 when the MS 106 comes within range of the WLAN 306. In some embodiments, this handover may be automatic. In another embodiment, the handover may include manual initiation or approval. It is understood that, while the first and second networks 102 and 302 may be referred to as WiMAX networks and the third network 306 referred to as a WLAN or Wi-Fi network for the sake of readability, the disclosed subject matter is not limited to any particular protocols and that the preferred or described embodiments are not the only possible embodiments.

In one embodiment, the handover may not include totally severing the association between the MS 106 and first WiMAX network 102. For example, in one embodiment, the MS 106 may enter a semi-idle mode in which some or all of the context information regarding the MS 106 is maintained by the BS 104 or other element of the network 102. In such an embodiment, the MS 106 may be able to re-enter or handover from the WLAN 306 to the first WiMAX network 102 more quickly than if the MS 106 had totally severed the association between the MS 106 and first WiMAX network 102.

In one embodiment, the relationship between the MS 106 and the BS 104 may include storing a significant amount of information by the BS 104. In one embodiment, the BS 104 may store information relating to the capabilities of the MS 106. Such capabilities may include the data rate and protocol support provided by the MS 106. In another embodiment, the BS 104 may store information related to the service flows used by the MS 106.

In one embodiment, a service flow may include a unidirectional flow of medium access control (MAC) service data units (SDUs) on a connection that is provided a particular quality of service (QoS). Such service flow information, in one embodiment, may include QoS information, a service flow identifier (SFID) that identifies the service flow, security information or security associations (SAs) including cryptographic keys, etc. The information may also include the connection identifier (CID) associated with the MS 106. In one embodiment, the CID may include a 16-bit value that identifies a connection between the BS and MS, in one embodiment, at the MAC level, and may be used to map a service flow or SAs to the MS 106. In one embodiment, this information may be referred to as context information.

As described above, when the MS 106 hands-over from the WiMAX network 102 to the WLAN 306, the MS 106 may instruct or request that the BS 104 maintain a certain amount of context information to facilitate the future re-entry of the MS 106 back into the WiMAX network 102. In one embodiment, the BS 104 may also maintain the data paths used by the service flows associated with the MS 106. In one embodiment, the data paths may include data routing and tunneling information used by the MS 106. Such data paths may exist between the BS 104 and an Access Network Gateway as shown in FIG. 1.

In various embodiments, once the MS 106 has left the range of the WLAN 306, or for other reasons, the MS 106 may re-enter the WiMAX network 102. In one embodiment, this maintained context information may be used to make the re-entry as seamless as possible. In one embodiment, the re-entry may occur automatically or with manual intervention.

In another embodiment, the MS 106 may move, physically or contextually, from the WLAN 306 to a second WiMAX network 302. In such an embodiment, the MS 106 may attempt to enter or perform a hand-over from the WLAN 306 to the WiMAX network 302. The BS 304 of the WiMAX network 302 may not include the context information needed to facilitate a seamless or near-seamless hand-over from the WLAN 306 to a second WiMAX network 302. In one embodiment, the WiMAX network 302 may simply start from scratch and create a whole new set of context information for the MS 106. In another embodiment, the BS 304 may request or obtain the context information related to the MS 106 from, directly or indirectly, the BS 104.

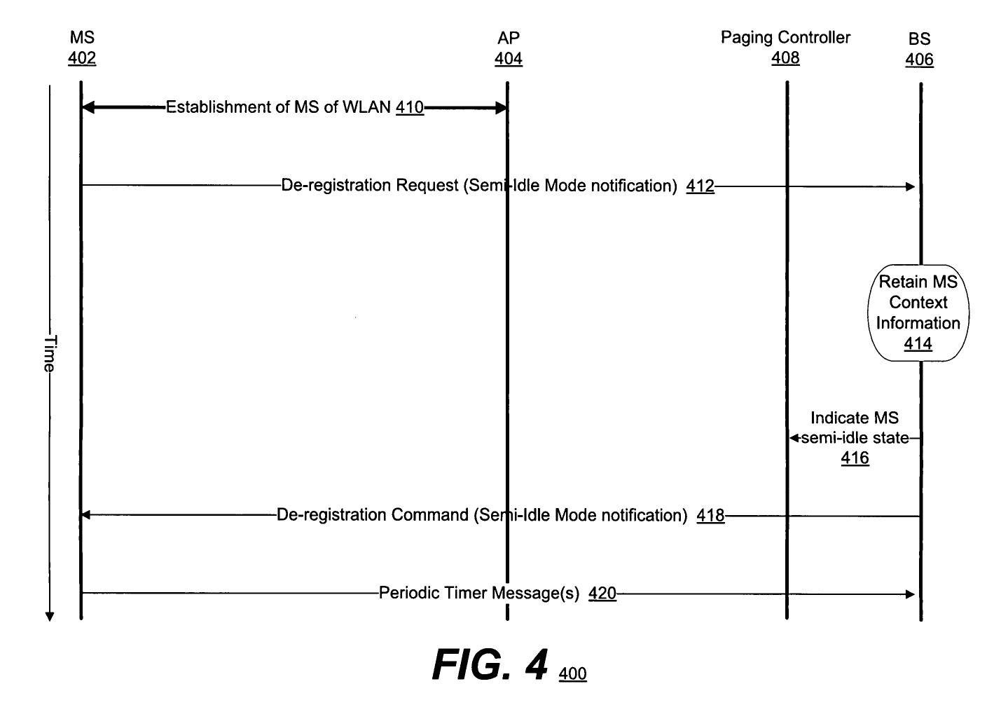

FIG. 4 is a timing diagram 400 of a wireless network in accordance with an example embodiment of the disclosed subject matter. In one embodiment, the timing diagram may illustrate a handover of a MS 402 from a WiMAX network to a WLAN or more generally of an apparatus from a network based upon a first protocol to a network based upon a second protocol. In various embodiments, the timing diagram 400 may include the use of a system that includes a MS 402, an access point (AP) 404, a paging controller (PC) 408, and a BS 406. In one embodiment, these devices may be illustrated in FIGS. 1 and 3.

In one such embodiment, the MS 402 may already be associated with the BS 406 and established on the WiMAX network via the BS 406. As part of the use of the WiMAX network, the MS 402 may have used or had made available to it a number of service flows. These service flows may have used or included various context information, as described above. Furthermore, the MS 402 may include context information, e.g., MS capabilities, that are not directly a result of any particular service flow; however, they may be associated with various service flows.

Action 410 illustrates that, in one embodiment, the MS 402 may associate itself with the AP 404. In one embodiment, the MS 402 may be established on the WLAN via the AP 404. In one embodiment, this may occur once the MS 402 has detected a reasonably strong WLAN signal; wherein reasonable strength is determined by a preconfigured value. In various embodiments, because the WiMAX network has a much greater range than a WLAN, the WiMAX network may continue to be available. Therefore, in one embodiment, the establishment of the MS 402 on the WLAN may occur at a leisurely pace without the loss of connectivity. Such establishment may include, in one embodiment, association with a WLAN AP 404, the assignment of an Internet Protocol (IP) address associated with the WLAN, and any QoS negotiation for expected data sessions using the WLAN. During this process, the WiMAX connection may be kept alive or active, and data traffic, via service flows, may continue as normal.

Action 412 illustrates that, in one embodiment, the MS 402 may notify the BS 406 that the MS 402 is entering a semi-idle mode with respect to the first (e.g., WiMAX) network. In various embodiments, the semi-idle mode may be associated with the MS 402 performing a handover from the first wireless network to a second wireless network (e.g., WiMAX to WiFi).

In one embodiment, action 412 may include the use of a de-registration request (DREG-REQ) sent from the MS 402 to the BS 406. In one embodiment, the request may include a field that indicates that the MS 402 is entering a semi-idle mode or, in another embodiment, is performing a handover from the WiMAX to the WiFi network. In some embodiments (e.g., a WiMAX embodiment) this field may be known as a Type/Length % Value (TLV). In various embodiments, the TLV may include a formatting scheme for passing variable fields and values using messages. In such an embodiment, the TLV may be known as a “Radio-idle Mode Indication”.

In some embodiments, the field may indicate that the MS 402 is entering an idle state, while another field indicates that the MS 402 is performing a handover to the WiFi network. In such an embodiment, the combination of the two (or more) fields may indicate to the BS 406 that the MS 402 is entering a semi-idle state or mode.

In one embodiment, an idle state may be differentiated from a semi-idle state in the way in which the BS 406 handles or maintains context related to the MS 402, as described below. Alternately, the idle and semi-idle states may also be differentiated, in one embodiment, by the intention or presumed intention of the MS 402. In one embodiment, the semi-idle state may indicate that the MS 402 intends to enter a relatively short period of inactivity on the WiMAX network and/or may wish to quickly re-enter the WiMAX network at a later time. Conversely, in one embodiment, the idle state may indicate that the MS 402 intends to enter a relatively longer period of network inactivity and/or is willing to use a more involved procedure to re-enter the WiMAX network.

Action 414 illustrates that, in one embodiment, the BS 406 may store or maintain at least a portion of the MS context information. In various embodiments, this MS context information may include, but is not limited to, storing QoS information associated with the MS 402, security information (e.g., an access key (AK) or traffic encryption key (TEK)) associated with the MS 402, MS capability information, general service flow information associated with the MS 402, etc. and as described above. In various embodiments, the BS 406 may release or no longer store all or most of the connection identifiers (CIDs) associated with MS 402.

In some embodiments, the BS 406 may determine which data paths were in use or allocated to the MS 402 or the service flows used or allocated to the MS 402. In such an embodiment, the BS 406 may maintain the associated data paths. As described above, a data path may include, in one embodiment, the routing and tunneling information used to transmit data. In one embodiment, maintaining may include storing the data path information and causing other devices to continue storing the data path information regardless of the disuse of the data path or service flow. In such an embodiment, the BS 406 may cause a gateway (GW) to “keep alive” the associated data paths between the BS 406 and the GW. Furthermore, in one embodiment, the BS 406 may cause the GW to maintain the data paths between the GW and any external or connectivity service networks (e.g., a network associated with the MS via a virtual private network (VPN), etc.).

Action 416 illustrates that, in one embodiment, the BS 406 may inform a paging controller 408 that the MS 402 has entered a semi-idle state or mode. In one embodiment, the paging controller 408 may control a paging group. In various embodiments, a paging group may be a group of base stations that allow a MS to roam freely and still receive occasional messages by being paged. In one embodiment, a MS may enter an idle or semi-idle mode and therefore no longer perform handovers or normal active mode operations as the MS moves from one BS to another. As a down-stream or down-link (e.g., an incoming data transmission directed to the MS) data transmissions occur a paging message may perform a broadcast informing the MS of the incoming down-stream message. In various embodiments, a BS may be part of multiple paging groups.

Action 418 illustrates that, in one embodiment, the BS 406 may respond to the De-registration Request 412 with a De-registration Command (DREG-CMD). In various embodiments, the DREG-CMD may be transmitted from the BS 406 to the MS 402 to force the MS 402 to change its access state or operating mode (e.g., to semi-idle mode). In some embodiments, the DREG-CMD may be transmitted in an unsolicited or solicited (as in FIG. 4) fashion. Upon receiving the DREG-CMD the MS 402 may take the indicated action. In one embodiment, illustrated by FIG. 4 the MS 402 may enter the requested semi-idle mode upon receipt of the DREG-CMD approval.

Action 420 illustrates that, in one embodiment, the MS 402 may transmit periodic timer messages (e.g., a location update message). In various embodiments, while being associated with the WLAN and in a semi-idle mode with respect to the WiMAX network, the MS 402 may perform a periodic location update to the WiMAX network. In some embodiments, the location update message may occur if any of four update conditions occur: Paging Group Update, Timer Update, Power Down Update, and/or MAC Hash Skip Threshold Update. Conversely, in other embodiments, MS 402 may also perform the Location Update process at will.

In one embodiment, the MS 402 may include a timer that regulates, at least in part, the transmission of these location update messages. In one embodiment, the time may countdown (or up, depending on the embodiment implementation details) to a predetermined value.

In one embodiment, the periodic timer message 420 may indicate that the MS 402 is still within range of the BS 406 and may, at a future time, request re-entry back into the network managed by the BS 406. The BS 406 may also include a timer configured to determine if a timer message is expected from the MS 402. In such an embodiment, the timers of the MS 402 and BS 406 may expire simultaneously, or near simultaneously. Conversely, in other embodiments, the BS 406 timer may be configured to expire after the MS 402 timer. In some embodiments, the BS 406 may reset when a timer message 420 is received from the MS 402.

In one embodiment, if the BS 406 timer expires before the BS 406 receives a timer message 420, the BS 406 may assume that the MS 402 is no longer associated with the BS 406. As such, the BS 406 may no longer maintain the MS's context information or associated data paths. The BS 406 may remove the MS context information from memory and de-allocate the associated data path(s). In one embodiment, this may involve de-allocating the data paths between the BS 406 and the GW. Conversely, in one embodiment, as long as the BS 406 receives the timer message 420, the BS 406 may continue to store the MS context information and data path(s).

In one embodiment, the MS 402 may not perform any data transfer operations on the WiMAX network while in semi-idle mode and actively associated with the WiFi network. However, in various embodiments, the MS 402 may transmit periodic timer updates or location update messages to the BS 406, as described above. Therefore, in such an embodiment, the BS 406 may only allocate uplink (from the MS to the BS) resources to the MS 402 in order to transmit the location update messages to the BS 406.

In another embodiment, the MS 402 may also be allocated uplink resources to transmit messages indicating or facilitating the re-entry of the MS 402 into the WiMAX network or the handover of the MS 402 from the WiMAX network to the WiFi network. In one embodiment, such messages may include ranging request, as described below. In one embodiment, the periodic location update may include the ranging request.

In one embodiment, no other BS in the first (e.g., WiMAX) network may include or maintain the MS context information while the MS is in a semi-idle mode. In another embodiment, multiple BS's may include the MS's context information, as described below.

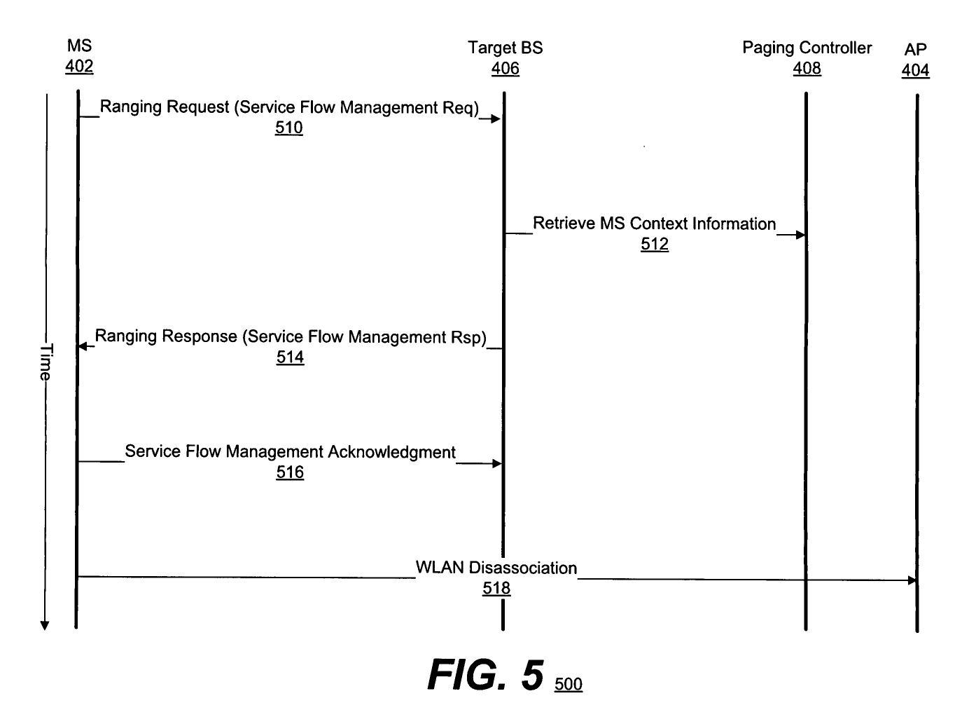

FIG. 5 is a timing diagram 500 of a wireless network in accordance with an example embodiment of the disclosed subject matter. In one embodiment, the timing diagram may illustrate a handover or re-entry of a MS 402 from a WLAN to a WiMAX network or more generally of an apparatus from a network based upon a second protocol to a network based upon a first protocol. In various embodiments, the timing diagram 400 may include the use of a system that includes a MS 402, an access point (AP) 404, a paging controller (PC) 408, and a target BS 406. In one embodiment, these devices may be illustrated in FIGS. 1 and 3.

In one embodiment, the MS 402 may be associated with a BS, known as a serving BS, that is part of a first network that uses a first networking protocol (e.g., a WiMAX network). The MS may also be associated with an AP 404 that is part of a second network that uses a second networking protocol (e.g., a WiFi network). In the embodiment of FIG. 5, the MS may start in a semi-idle mode with respect to the WiMAX network and actively be communicating or associated with the WiFi network. If the MS 402 wishes to re-enter the WiMAX network or perform a handover form the WiFi network to the WiMAX network, the MS 402 may inform the BS, now referred to as target BS 406. In the embodiment, of FIG. 5 the serving BS that was last used by the MS 402 when the MS 402 left the WiMAX network and the target BS 406 used to re-enter the WiMAX network may be the same BS; however, it is understood that this may not always be the case, as described in relation to other figures.

Action 510 illustrates that, in one embodiment, the MS 402 may transmit a reentry request to the BS 406 indicating that the MS 402 is initiating a handover from a non-WiMAX network (e.g., a WiFi network) to the WiMAX network. In one embodiment, this reentry request may include a ranging request (RNG-REQ).

In one embodiment, the RNG-REQ 510 or similar message may be a Medium Access Control (MAC) management message. In such an embodiment, a RNG-REQ may be transmitted from the MS 402 to, in part, determine the network delay and to request power and/or downlink burst profile changes. In one embodiment, the RNG-REQ 510 may include a ranging purpose indication field or TLV. In some embodiments, this ranging purpose indication field may indicate that the MS 402 is currently attempting a network re-entry. In specific embodiments, the RNG-REQ 510 ranging purpose indication field may include a bit #0 set to logical 1.

In one embodiment, the RNG-REQ 510 may include a Paging Controller ID field or TLV. In various embodiments, the Paging Controller ID may include a logical network identifier associated with the serving BS (or other network entity) retaining MS 402 service and operational context information and/or administering paging activity for the MS 402. In some embodiments, this field accompanied by setting the bit #0 of the ranging purpose indication field to logical 1 may indicate that the MS 402 is attempting network re-entry as opposed to a handover from one BS to another.

In one embodiment, the reentry request 510 may include an indication that the MS 402 is currently connected to a WLAN, WiFi network, or other network using a different protocol from the BS 406.

In one embodiment, the reentry request 510 may include a service flow management request. In various embodiments, the service flow management request may be part of the RNG-REQ. In other embodiments, the service flow management request may include one or more separate messages. In various embodiments, the service flow management request may inform the BS 406 of the service flows the MS 402 would like to have established. In some embodiments, the request may simply ask for the previous service flows (previous to the WiMAX to WLAN handover) to be reestablished, modified or released. In one embodiment, the service flow management request may indicate which of the previous service flows are desired. In another embodiment, the service flow management request may indicate which of new service flows should be established.

For example, while the MS 402 was communicating via the second or non-WiMAX network various communications or non-WiMAX “service flows” may have been closed or opened between the MS 402 and other devices. The BS 406 may not be initially aware of the change in communication patterns. Therefore, the MS 402 may inform the BS 406 that certain service flows are no longer needed and that other newer service flows may be desired. It is understood that the protocol used on the second or non-WiMAX network may not include the concept of service flows and that some translation or conversion may be required during the handover to communicate the needs of the MS 402. Likewise, some conversion may have been required when performing the initial handover to the non-WiMAX network to provide for the initial needs of the MS 402.

In one embodiment, the information included in the RNG-REQ 510 may include information normally associated, in the WiMAX protocol, with the Dynamic Service Addition Request (DSA-REQ), Dynamic Service Change Request (DSC-REQ), and Dynamic Service Deletion Request (DSD-REQ). These service change responses may include MAC management messages requesting the, respectively, addition, changing, or deletion of service flows and the association of the service flows to the MS 402. In other embodiments, the Action 510 may include the RNG-REQ and some or all of the above mentioned service change responses. In one embodiment, the MS 402 may request special bandwidth allocation for any combined RNG-REQ and DSA/DSC/DSD-REQ messages. In embodiments using a protocol other than WiMAX, other messages may be used and the disclosed subject matter is not limited to any one protocol.

In one embodiment, the target BS 406 may determine whether or not the BS 406 includes the context information for the MS. In such an embodiment, the determination may include determining if the MS context information is still valid. If so, the BS 406 may skip Action 512, or, in some embodiments, Action 512 may include retrieving the MS context information from the BS 406.

If not, Action 512 illustrates that, in one embodiment, the BS 406 may request the MS's context information from another device. In one embodiment, this other device may include a paging controller 408. In such an embodiment, the BS 406 may have received the paging control ID as part of the reentry request 510.

In various embodiments, the MS context information may allow the BS 406 to perform a fast handover from the Wi-Fi network to the WiMAX network. In this context, the term “fast handover” may mean that the service flow and data path information may be readily available and therefore, need not be queried and reconstructed.

In various embodiments, once the BS 406 has retrieved the MS context information, it may begin to perform the fast handover of the MS 402 from the non-WiMAX network to the WiMAX network. Action 514 illustrates that, in one embodiment, the BS 406 may respond to the RNG-REQ 510 with a ranging response (RNG-RSP) message. In one embodiment, the RNG-RSP 514 may include a MAC management message responding to the RNG-REQ 510.

In some embodiments, the RNG-RSP 514 may include a service flow management response field or set of fields (or TLVs). In such an embodiment, the service flow management field(s) may indicate to the MS 402 which service flows are being restored or are available to the MS 402 for use. In various embodiments, the service flow management response message may be a separate message or series of messages.

In other embodiments, the RNG-RSP 514 may include a handover optimization field or TLV that indicates a handover optimization scheme to be used by the MS 402 and BS 406 to reduce the overhead associated with the hand over process. It is understood that the disclosed subject matter is not limited is not limited to any one handover optimization scheme.

In one embodiment, the information included in the RNG-RSP 514 may include information normally associated, in the WiMAX protocol, with the Dynamic Service Addition Response (DSA-RSP), Dynamic Service Change Response (DSC-RSP), and Dynamic Service Deletion Response (DSD-RSP). These service change responses may include MAC management messages that, respectively, add, change, or delete service flows and the association of the service flows to the MS 402, and assigns connection identifier to the associated service flow. In other embodiments, the Action 514 may include the RNG-RSP and some or all of the above mentioned service change responses. In embodiments using a protocol other than WiMAX, other messages may be used and the disclosed subject matter is not limited to any one protocol.

Action 516 illustrates that, in one embodiment, the MS 402 may respond to the service flow management response 514 with a service flow management acknowledgement 516. In one embodiment, the service flow management acknowledgment 516 may indicate which of the available or restorable service flows are desired. In another embodiment, the service flow management acknowledgment 516 may indicate which of new service flows should be established.

For example, while the MS 402 was communicating via the second or non-WiMAX network various communications or non-WiMAX “service flows” may have been closed or opened between the MS 402 and other devices. The BS 406 may not be initially aware of the change in communication patterns. Therefore, the MS 402 may inform the BS 406 that certain service flows are no longer needed and that other newer service flows may be desired. It is understood that the protocol used on the second or non-WiMAX network may not include the concept of service flows and that some translation or conversion may be required during the handover to communicate the needs of the MS 402. Likewise, some conversion may have been required when performing the initial handover to the non-WiMAX network to provide for the initial needs of the MS 402.

Action 518 illustrates that, in one embodiment, once the MS 402 has sufficiently re-entered the WiMAX network (e.g., capable of communicating via the WiMAX network using the requested service flows), the MS 402 may disassociate itself from the WiFi or non-WiMAX network. In various embodiments, this may include the MS 402 transmitting and receiving one or more messages to the AP 404. In other embodiments, disassociation may include ceasing transmissions via the second network.

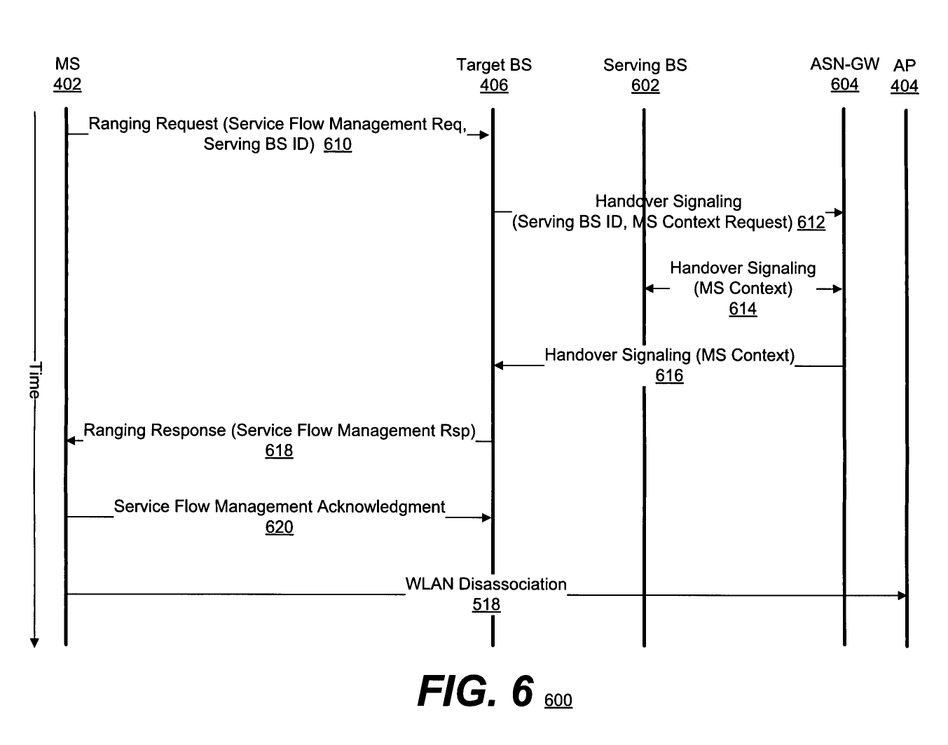

FIG. 6 is a timing diagram 600 of a wireless network in accordance with an example embodiment of the disclosed subject matter. In one embodiment, the timing diagram may illustrate a handover or re-entry of a MS 402 from a WLAN to a WiMAX network or more generally of an apparatus from a network based upon a second protocol to a network based upon a first protocol. In various embodiments, the timing diagram 400 may include the use of a system that includes a MS 402, an access point (AP) 404, a target BS 406, a serving BS 602, and an Access Network Gateway (ASN-GW) 604. In one embodiment, these devices may be illustrated in FIGS. 1 and 3.

In this and similar embodiments, the target BS 406 may not be the same as the serving BS 602. For example, the MS 402 may move out of the range of the serving BS 602 and into the range of the target BS 406. In another example, the MS 402 may still be within range of the serving BS 406 but the MS may receive a better signal from the target BS 602. It is understood that the above are merely a few illustrative examples to which the disclosed subject matter is not limited.

Action 610 illustrates that, in one embodiment, the MS 402 may transmit a reentry request to the target BS 406 indicating that the MS 402 is initiating a handover from a non-WiMAX network (e.g., a WiFi network) to the WiMAX network. In one embodiment, this reentry request may include a ranging request (RNG-REQ).

In one embodiment, the RNG-REQ 610 or similar message may be a Medium Access Control (MAC) management message, as described above. In one embodiment, the RNG-REQ 610 may include a ranging purpose indication field or TLV. In some embodiments, this ranging purpose indication field may indicate that the MS 402 is currently attempting a network re-entry. In specific embodiments, the RNG-REQ 610 ranging purpose indication field may include a bit #0 set to logical 1.

In one embodiment, the RNG-REQ 610 may include a Base Station ID field or TLV. In various embodiments, the Base Station ID (BSID) may include a logical network identifier associated with the serving BS to which the MS 402 is currently connected and is expected to have the MS's context information. In one embodiment, the serving BSID may not be included if the periodical timer is timed-out. In various embodiments, inclusion of the serving BSID in the RNG-REQ 610 message signals to the target BS 406 that the MS 402 is currently connected to the network through the serving BS 602 and is requesting the process of handover network re-entry. In some embodiments, the BSID field may be accompanied by setting the bit #0 of the ranging purpose indication field to logical 1 to indicate that the MS 402 is attempting network re-entry that includes a handover from one BS to another.

In one embodiment, the reentry request 610 may include an indication that the MS 402 is currently connected to a WLAN, WiFi network, or other network using a different protocol from the BS 406. In another embodiment, the reentry request 610 may include a service flow management request, as described above.

In one embodiment, the MS 402 may determine whether or not to provide the serving BS 602 ID or the paging controller ID based upon the state of the MS's periodic timer. In one embodiment, if the periodic timer has expired, the MS may transmit the BSID to the target BS 406 as part of the reentry request 610. In other embodiments, if the periodic timer has not expired, the MS may transmit the Paging Controller ID to the target BS 406 as part of the reentry request 610.

Action 612 illustrates that, in one embodiment, the Target BS 406 may then request the handover signaling information from the serving BS 602. In one embodiment, the handover signaling information may include the MS context information and, in some embodiments, reassignment of any data paths from the serving BS 602 to the target BS 406. In the embodiment illustrated by FIG. 5, the target BS 406 may request this information via the ASN-GW 604 or, in other embodiments, a third device, such as for example a paging controller 408. In one embodiment, the handover signaling 612 may include fields or TLVs indicating the serving BSID and the MS context request.

Action 614 illustrates that, in one embodiment, the ASN-GW 604 may forward the handover request or send an equivalent request to the serving BS 602. In response the BS 602 may provide the ASN-GW 604 with the MS context information and any other information required for a BS-to-BS handover as dictated by the networking protocol of the first network (e.g., a WiMAX network). In one embodiment, the handover signaling 614 may include a request for the serving BS 602 to remove the MS context information from memory. In various embodiments, this removal may be the same or similar to the removal that would occur if the BS's periodical timer expired without receiving a timer update message from the MS 402. Action 616 illustrates that, in one embodiment, the ASN-GW 604 may provide this information to the target BS 406.

Action 618 illustrates that, in one embodiment, the BS 406 may respond to the RNG-REQ 610 with a ranging response (RNG-RSP) message. In one embodiment, the RNG-RSP 618 may include a MAC management message responding to the RNG-REQ 610.

In some embodiments, the RNG-RSP 618 may include a service flow management response field or set of fields (or TLVs), as described above. In other embodiments, the RNG-RSP 618 may include a handover optimization field or TLV that indicates a handover optimization scheme to be used by the MS 402 and BS 406 to reduce the overhead associated with the hand over process. It is understood that the disclosed subject matter is not limited is not limited to any one handover optimization scheme.

Action 620 illustrates that, in one embodiment, the MS 402 may respond to the service flow management response 618 with a service flow management acknowledgement 620. In one embodiment, the service flow management acknowledgment 620 may indicate which of the available or restorable service flows are desired. In another embodiment, the service flow management acknowledgment 620 may indicate which new service flows should be established.

Action 518 illustrates that, in one embodiment, once the MS 402 is sufficiently re-entered the WiMAX network (e.g., capable of communicating via the WiMAX network using the requested service flows), the MS 402 may disassociate itself from the WiFi or non-WiMAX network. In various embodiments, this may include the MS 402 transmitting and receiving one or more messages to the AP 404. In other embodiments, disassociation may include ceasing transmissions via the second network.

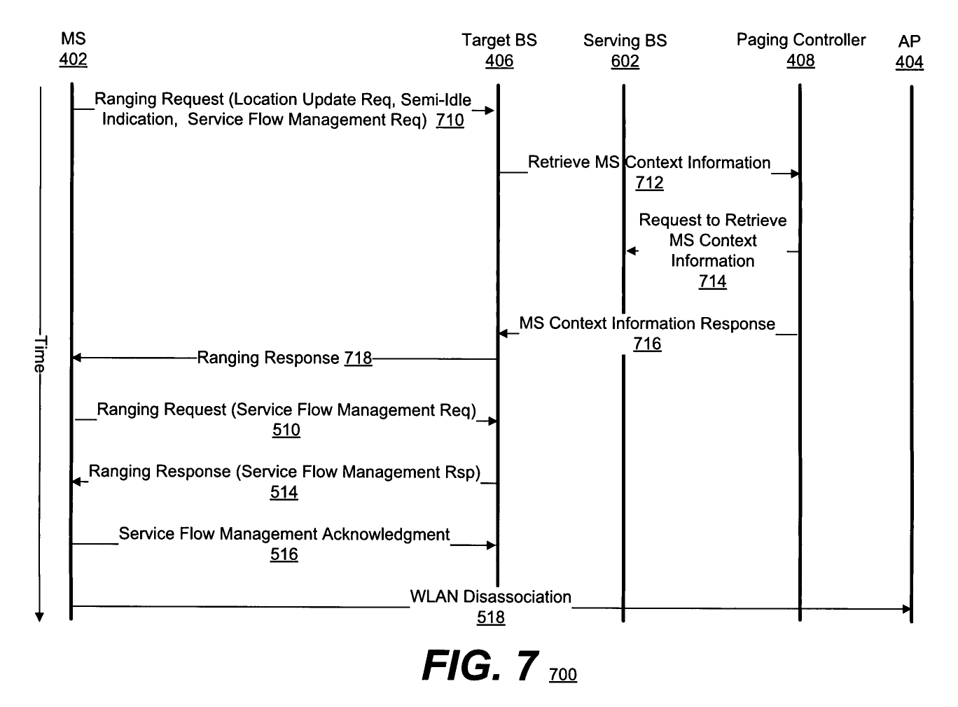

FIG. 7 is a timing diagram 700 of a wireless network in accordance with an example embodiment of the disclosed subject matter. In one embodiment, the timing diagram may illustrate a handover or re-entry of a MS 402 from a WLAN to a WiMAX network or more generally of an apparatus from a network based upon a second protocol to a network based upon a first protocol. In various embodiments, the timing diagram 400 may include the use of a system that includes a MS 402, an access point (AP) 404, a paging controller (PC) 408, a target BS 406, and a serving BS 602. In one embodiment, these devices may be illustrated in FIGS. 1 and 3.

Action 710 illustrates that, in one embodiment, while the MS 402 is still actively connected with the AP 404, it may detect a second BS 406. Even though the MS 402 may not intend to re-enter the first (e.g., WiMAX) network yet, it may perform a location update with the second BS 406. In one embodiment, this location update 710 may include a request to associate the MS 402 with the BS 406, even though the MS 402 is not currently re-entering the network.

In one embodiment, the location update 710 may include a ranging request (RNG-REQ), as described above. In one embodiment, the RNG-REQ 710 may include a ranging purpose indication field or TLV. In some embodiments, this ranging purpose indication field may indicate that the MS 402 is currently in a semi-idle mode and not attempting a network re-entry. In specific embodiments, the RNG-REQ 710 ranging purpose indication field may include a bit #1 set to logical 1 (in contrast to bit #0 of the RNG-REQ 510 above).

In one embodiment, the RNG-REQ 710 may include a Paging Controller ID field or TLV. In one embodiment, the RNG-REQ 710 may include a location update request, as described above. In one embodiment, the RNG-REQ 710 may also include a field or TLV that indicates that the MS 402 is currently associated with a non-WiMAX network (e.g., a WLAN or WiFi network).

In one embodiment, the RNG-REQ 710 may include a service flow management request. In various embodiments, the service flow management request may be similar to that of Action 510 of FIG. 5, as described above. In various embodiments, the MS 402 may transmit the service flow management request as part of either Actions 710 or 510, or both or neither Action.

Action 712 illustrates that, in one embodiment, the target BS 406 may, in response to the RNG-REQ 710, retrieve the MS's context information from the paging controller 408. Action 714 illustrates that, in one embodiment, the paging controller 408 may request the MS context information from the serving BS 714.

Action 716 illustrates that, in one embodiment, the PC 408 may then provide this MS context information to the target BS 406. In other embodiments, the PC 408 may already include the MS context information and directly provide it to the BS 406.

In various embodiments, the PC 408 may not request that or inform the serving BS 602 not to delete the MS context information. In such an embodiment, it may still be possible for the MS 402 to re-enter the network via the serving BS 602. In some embodiments, both the target BS 406 and the serving BS 602 may include the MS context information (after Action 716). In such an embodiment, the MS 402 may choose re-enter the WiMAX network via either BS. However, in system 700, the re-entry via target BS 406 may now be faster than it would be compared to system 600. In a sense, the system 700 has speculatively pre-loaded the target BS 406 with the MS context information. However, if the MS 402 eventually decides to not enter the network or re-enter the network via BS 602 the network resources used to copy the MS context information to the target BS 406 may be wasted, in whole or part. In one embodiment, the MS 406 may now provide periodic location updates to both the target BS 406 and the serving BS 602.

Action 718 illustrates that, in one embodiment, the MS 402 may receive a ranging response from the Target BS 406, as a result of Action 710. In various embodiments, the ranging response 718 may include a service flow management response as described in relation to Action 514 above. In some embodiments, the ranging response 718 may include responses to the location update and semi-idle indication of Action 710.

Action 510 illustrates that, in one embodiment, the MS 402 may eventually attempt to re-enter the WiMAX network via the target BS 406 by sending a RNG-REQ, as described above. In such an embodiment, the target MS 406 may not need to request the MS context information from the PC 408 as had previously been done in system 500 of FIG. 5 or request the information from the serving BS 602 as had previously been done in system 600 of FIG. 6. Action 514 illustrates that, in one embodiment, the target BS 406 may respond to the ranging request, as described above. Action 516 illustrates that, in one embodiment, the MS 402 may provide a service flow acknowledgement, as described above. Action 518 illustrates that the MS 402 may disassociate itself from the WLAN or WiFi network, as described above.

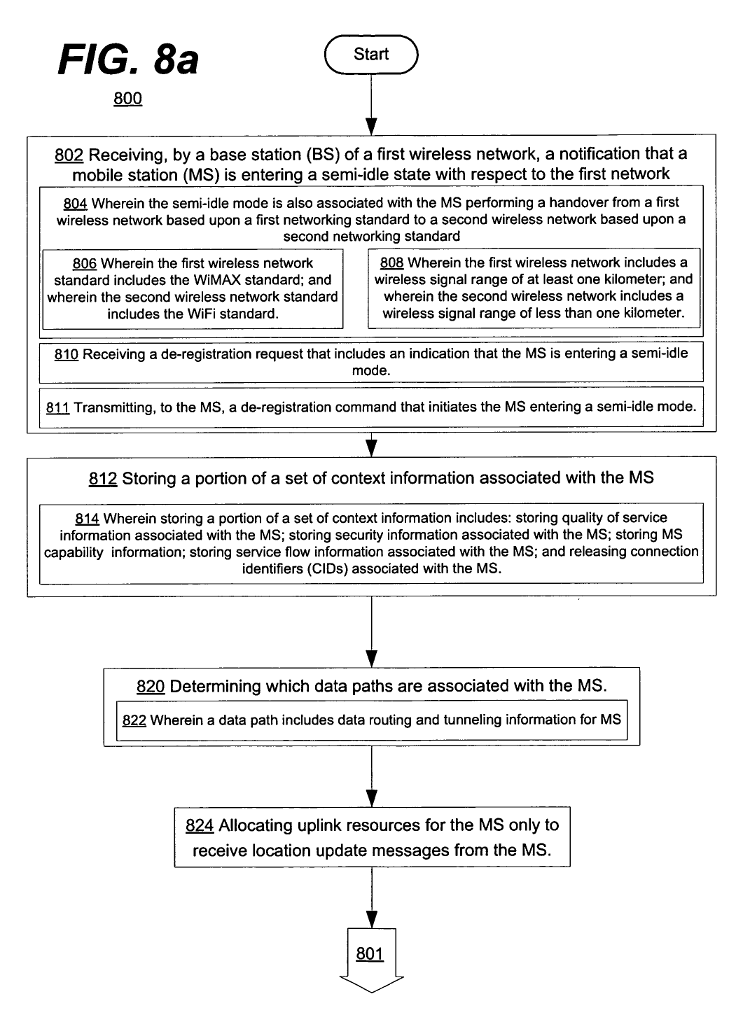

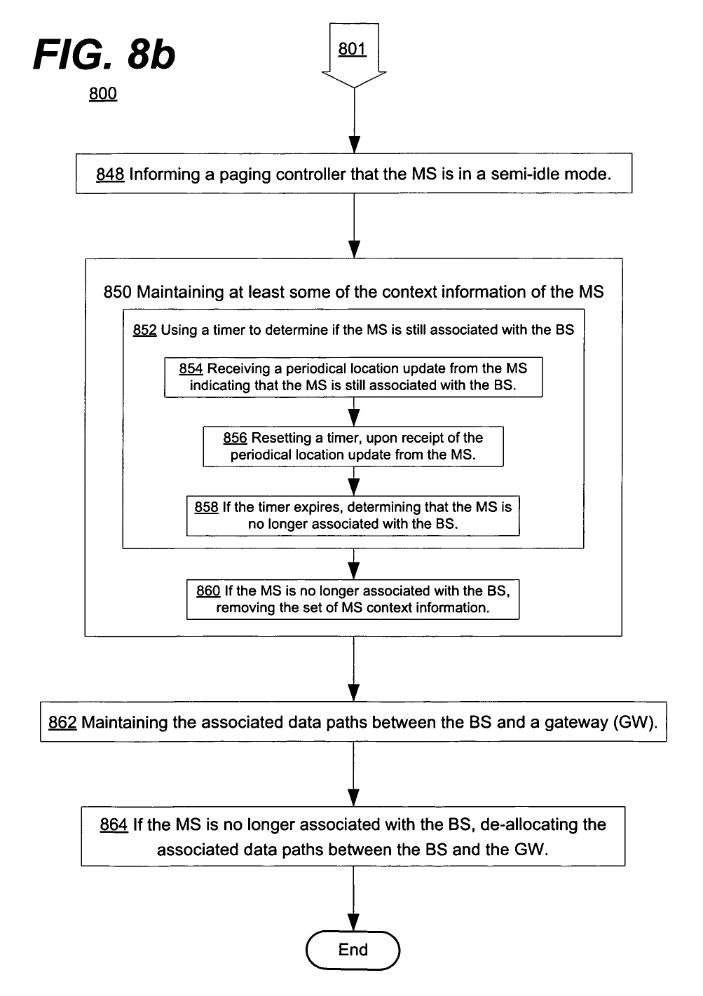

FIG. 8 is a flowchart of a technique 800 in accordance with an example embodiment of the disclosed subject matter. In various embodiments, parts or all of the technique 900 may be used to produce a system or apparatus confirming to the timing diagrams of FIG. 4. Although, it is understood that other systems and timing diagrams my result from the use of technique 800. Furthermore, it is understood that FIGS. 8a and 8b represent a single flowchart illustrated on two pages and connected via connector 801, here-before and here after the two pages will simply be referred to as FIG. 8.

Block 802 illustrates that, in one embodiment, a base station (BS) of a first wireless network may receive a notification that a mobile station (MS) is entering a semi-idle state with respect to the first network, as described above. Block 804 illustrates that, in one embodiment, that the semi-idle mode may also associated with the MS performing a handover from a first wireless network based upon a first networking standard to a second wireless network based upon a second networking standard. In one embodiment, the wireless transceiver 202 of FIG. 2 or the BS 406 of FIG. 4 may receive the message.

Block 806 illustrates that, in one embodiment, the first wireless network standard may include the WiMAX standard; and the second wireless network standard may include the WiFi standard. Block 808 illustrates that, in one embodiment, the first wireless network may include a wireless signal range of at least one kilometer; and the second wireless network may include a wireless signal range of less than one kilometer. In one embodiment, the network 102 of FIG. 3 may act as the first network. In one embodiment, the network 306 of FIG. 3 may act as the second network.

Block 810 illustrates that, in one embodiment, receiving may include receiving a de-registration request that an indication that the MS is entering a semi-idle mode, as described above. In one embodiment, the wireless transceiver 202 of FIG. 2 or the BS 406 of FIG. 4 may receive the message.

Block 811 illustrates that, in one embodiment, receiving may include transmitting, to the MS, a de-registration command that initiates the MS entering a semi-idle mode, as described above. In various embodiments, the BS may then receive a response from the MS indicating that the command has been received. In one embodiment, the wireless transceiver 202 of FIG. 2 or the BS 406 of FIG. 4 may transmit the message.

Block 812 illustrates that, in one embodiment, a portion of a set of context information associated with the MS may be stored. Block 814 illustrates that, in one embodiment, storing may include storing quality of service information associated with the MS; storing security information associated with the MS; storing MS capability information; storing service flow information associated with the MS; and releasing all or most of the connection identifiers (CIDs) associated with the MS, as described above. In one embodiment, the controller 204 of FIG. 2 or the BS 406 of FIG. 4 may store the context information.

Block 820 illustrates that, in one embodiment, a determination may be made as to what data paths are associated with the MS. In one embodiment, these data paths may be associated with the service flows associated with the MS. Block 822 illustrates that, in one embodiment, the data path may include data routing and tunneling information and associated resources, as described above. In one embodiment, the controller 204 of FIG. 2 or the BS 406 of FIG. 4 may determine the data paths, as described above.

Block 824 illustrates that, in one embodiment, uplink resources may be allocated only to receive location update messages or handover/network reentry request from the MS, as described above. In one embodiment, the controller 204 of FIG. 2, or the BS 406 of FIGS. 4, 5 & 6 may perform the allocation.

Block 848 illustrates that, in one embodiment, the BS may inform a paging controller that the MS has entered a semi-idle mode, as described above. In one embodiment, the transceiver 202 of FIG. 2, or the BS 406 of FIG. 4 may inform the paging controller.

Block 850 illustrates that, in one embodiment, at least some of the context information of the MS may be maintained while the MS is in a semi-idle state, as described above. Block 860 illustrates that, in one embodiment, if the MS is no longer associated with the BS the context information may be removed, as described above. In one embodiment, the controller 204 of FIG. 2, or the BS 406 of FIGS. 4, 5 & 6 may maintain the context information.

Block 852 illustrates that, in one embodiment, a timer maybe used to determine is the MS is still associated with the BS, as described above. In one embodiment, the timer 206 of FIG. 2, or the BS 406 of FIGS. 4, 5 & 6 may be used. Block 854 illustrates that, in one embodiment, a periodic or periodical location update from the MS may be received. Wherein the location update may indicate that the MS is still associated with the BS, as described above. In one embodiment, the transceiver 202 of FIG. 2, or the BS 406 of FIGS. 4, 5 & 6 may receive the signal.

Block 856 illustrates that, in one embodiment, upon receipt of the periodical location update from the MS, the timer may be reset, as described above. Block 858 illustrates that, in one embodiment, if the timer expires, it may be determined that the MS is no longer associated with the BS. In one embodiment, the controller 204 of FIG. 2, or the BS 406 of FIGS. 4, 5 & 6 may perform these actions.

Block 862 illustrates that, in one embodiment, the data paths may be maintained between the BS and the gateway (GW), as described above. Block 864 illustrates that, in one embodiment, if the MS is no longer associated with the BS, the data paths may be de-allocated, as described above. In one embodiment, the controller 204 of FIG. 2, or the BS 406 of FIGS. 4, 5 & 6 may perform these actions. In one embodiment, maintaining the data paths may be part of maintaining the MS context information.

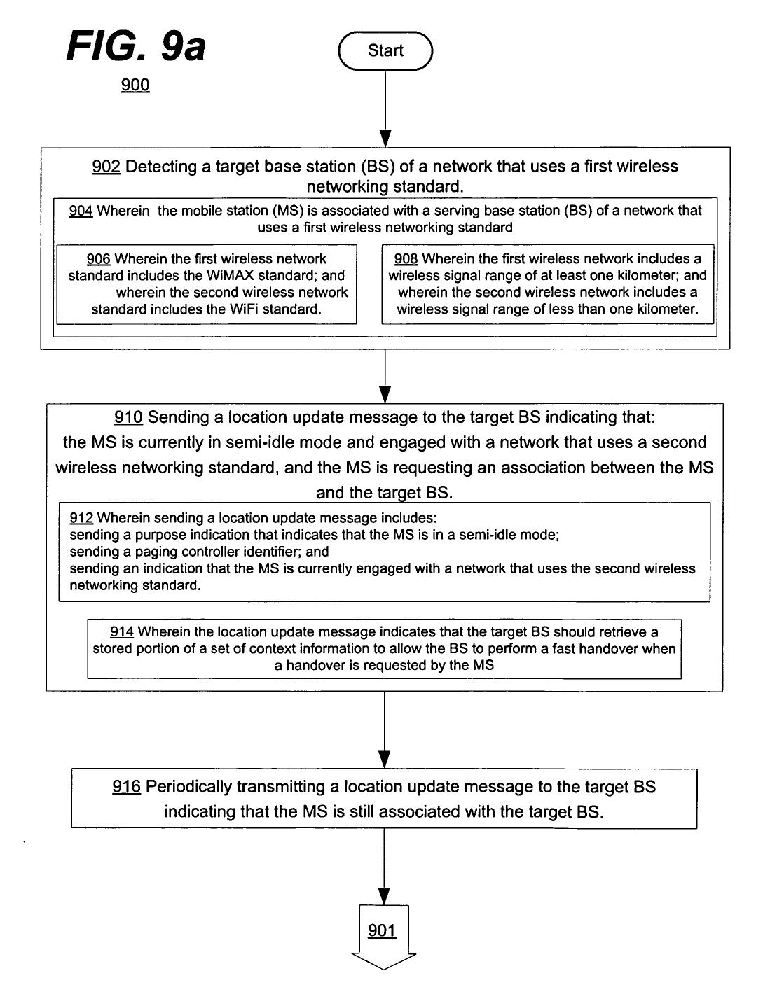

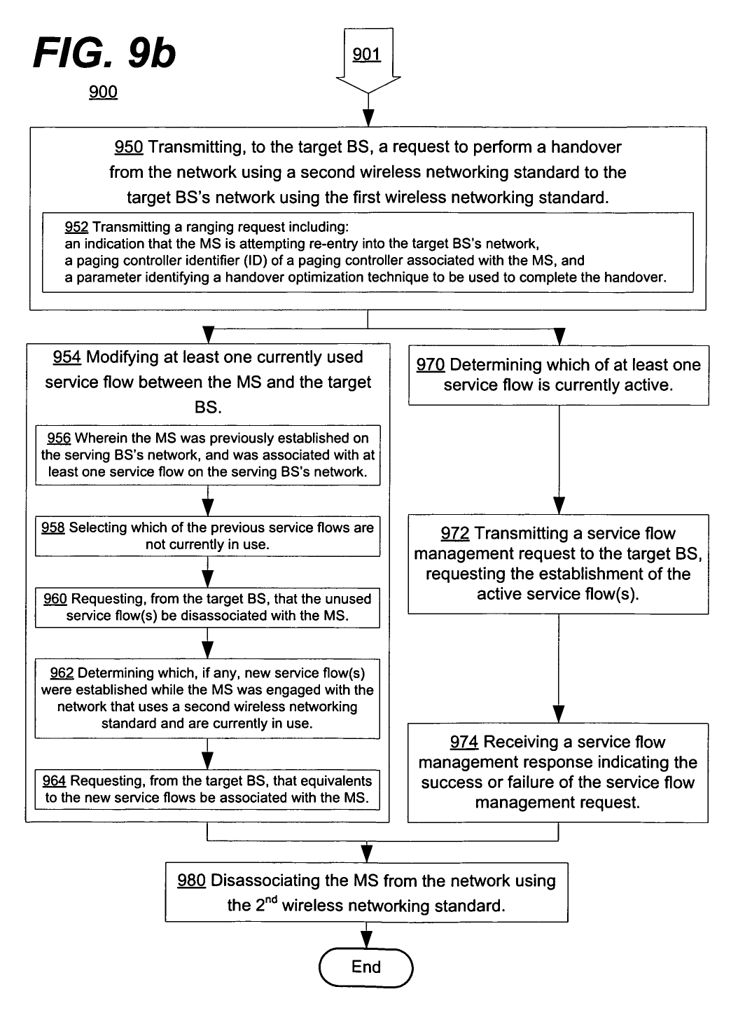

FIG. 9 is a flowchart of a technique 900 in accordance with an example embodiment of the disclosed subject matter. In various embodiments, parts or all of the technique 900 may be used to produce a system or apparatus confirming to the timing diagrams of FIGS. 5, 6 and 7. Although, it is understood that other systems and timing diagrams my result from the use of technique 900. Furthermore, it is understood that FIGS. 9a and 9b represent a single flowchart illustrated on two pages and connected via connector 901, here-before and here after the two pages will simply be referred to as FIG. 9.

Block 902 illustrates that, in one embodiment, a MS may detect target base station (BS) of a network that uses a first wireless networking standard, as described above. Block 904 illustrates that, in one embodiment, the MS may already be associated with a serving base station (BS) of a network that uses a first wireless networking standard, as described above. In one embodiment, the transceiver 217 of FIG. 2, or the MS 402 of FIGS. 5, 6 & 7 may perform these actions.

Block 906 illustrates that, in one embodiment, the first wireless network standard may include the WiMAX standard and the second wireless network standard may include the WiFI standard, as described above. Block 908 illustrates that, in one embodiment, the first wireless network may include a wireless signal range of at least one kilometer; and the second wireless network may include a wireless signal range of less than one kilometer. In one embodiment, the networks 102 or 302 of FIG. 3 may act as the first network. In one embodiment, the network 306 of FIG. 3 may act as the second network.

Block 910 illustrates that, in one embodiment, 910 a location update message may be sent to the target BS indicating that the MS is currently engaged with a network that uses a second wireless networking standard, and the MS is requesting an association between the MS and the target BS, as described above. In one embodiment, the transceiver 217 of FIG. 2, or the MS 402 of FIGS. 5, 6 & 7 may perform these actions.

Block 912 illustrates that, in one embodiment, sending may include sending a location update message includes: sending a purpose indication that indicates that the MS is in an idle mode, sending a paging controller identifier, and sending an indication that the MS is currently engaged with a network that uses the second wireless networking standard, as described above. Block 914 illustrates that, in one embodiment, the location update message may indicate that the target BS should retrieve a stored portion of a set of context information to allow the BS to perform a fast handover when a handover is requested by the MS, as described above. In various embodiments, the transceiver 217 of FIG. 2, or the MS 402 of FIGS. 5, 6 & 7 may send these messages.

Block 916 illustrates that, in one embodiment, the MS may periodically transmit a location update message to the target BS indicating that the MS is still associated with the target BS, as described above. In various embodiments, the transceiver 217 of FIG. 2, or the MS 402 of FIGS. 5, 6 & 7 may send this message.

Block 950 illustrates that, in one embodiment, the MS may 950 transmit, to the target BS, a request to perform a handover from the network using a second wireless networking standard to the target BS's network using the first wireless networking standard, as described above. Block 952 illustrates that, in one embodiment, transmitting may include transmitting a ranging request including: an indication that the MS is attempting re-entry into the target BS's network, a paging controller identifier (ID) of a paging controller associated with the MS, and a parameter identifying a handover optimization technique to be used to complete the handover, as described above. In various embodiments, the transceiver 217 of FIG. 2, or the MS 402 of FIGS. 5, 6 & 7 may send these messages.

Block 954 illustrates that, in one embodiment, at least one currently used service flow between the MS and the target BS may be established, re-established or modified, as described above. Block 956 illustrates that, in one embodiment, the MS may have been previously established on the serving BS's network, and was associated with at least one service flow on the serving BS's network, as described above. Block 958 illustrates that, in one embodiment, the MS may select which of the previous service flows are not currently in use, as described above, as described above. Block 960 illustrates that, in one embodiment, establishing may include requesting, from the target BS, that the unused service flow(s) be disassociated with the MS, as described above. Block 962 illustrates that, in one embodiment, that establishing may include determining which, if any, new service flow(s) were established while the MS was engaged with the network that uses a second wireless networking standard and are currently in use, as described above. Block 964 illustrates that, in one embodiment, establishing may include requesting, from the target BS, that equivalents to the new service flows be associated with the MS, as described above. In various embodiments, the mobile station 211 of FIG. 2 or its components, or the MS 402 of FIGS. 5, 6 & 7 may establish the service flows, as described above.

Block 970 illustrates that, in one embodiment, the MS may determine which of at least one service flow is active. In various embodiments, the controller 214 of FIG. 2, or the MS 402 of FIGS. 5, 6 & 7 may make this determination, as described above.

Block 972 illustrates that, in one embodiment, the MS may transmit a service flow management request to the target BS, requesting the establishment of the active service flow(s), as described above. Block 974 illustrates that, in one embodiment, the MS may receiving a service flow management response indicating the success or failure of the service flow management request, as described above. In various embodiments, the transceiver 217 of FIG. 2, or the MS 402 of FIGS. 5, 6 & 7 may send or receive these messages, as described above.

Block 980 illustrates that, in one embodiment, the MS may disassociate from the second network using the second wireless networking standard, as described above. In one embodiment, the transceiver 218 or controller 214 of FIG. 2, or the MS 402 of FIGS. 5, 6 & 7 may disassociate, as described above.

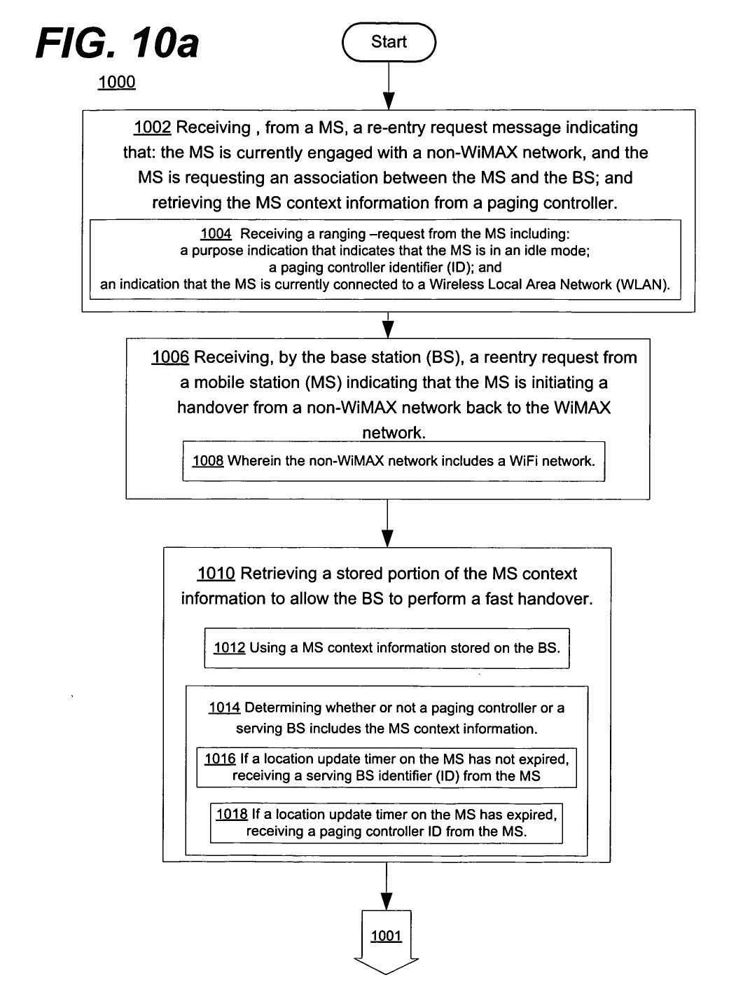

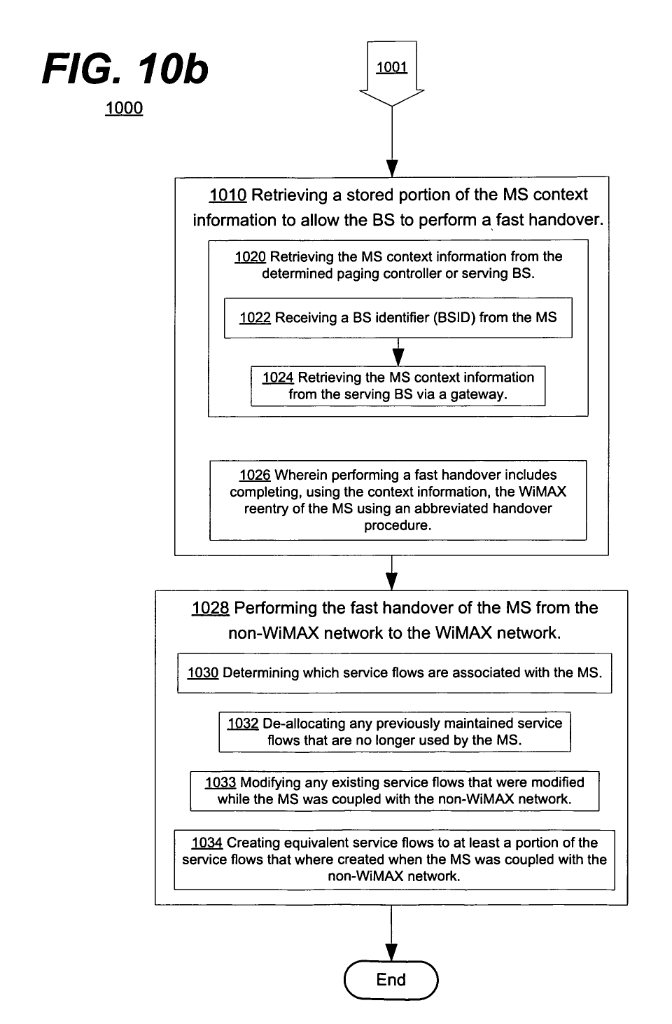

FIG. 10 is a flowchart of a technique 1000 in accordance with an example embodiment of the disclosed subject matter. In various embodiments, parts or all of the technique 1000 may be used to produce a system or apparatus confirming to the timing diagrams of FIGS. 5, 6 and 7. Although, it is understood that other systems and timing diagrams my result from the use of technique 1000. Furthermore, it is understood that FIGS. 10a and 10b represent a single flowchart illustrated on two pages and connected via connector 1001, here-before and here after the two pages will simply be referred to as FIG. 10.

Block 1002 illustrates that, in one embodiment, a BS may receive, from a MS, a re-entry request message indicating that: the MS is currently engaged with a non-WiMAX network, and the MS is requesting an association between the MS and the BS; and retrieving the MS context information from a paging controller, as described above. Block 1004 illustrates that, in one embodiment, receiving may include receiving a ranging-request from the MS including: a purpose indication that indicates that the MS is in an idle mode, a paging controller identifier (ID), and an indication that the MS is currently connected to a Wireless Local Area Network (WLAN). In one embodiment, the transceiver 202 of FIG. 2, or the BS 406 of FIG. 7 may receive the location update or re-entry request message, as described above.

Block 1006 illustrates that, in one embodiment, the BS may receive a reentry request from a mobile station (MS) indicating that the MS is initiating a handover from a non-WiMAX network back to the WiMAX network, as described above. Block 1008 illustrates that, in one embodiment, the non-WiMAX network may include a WiFi network, as described above. In one embodiment, the transceiver 202 of FIG. 2, or the BS 406 of FIGS. 5, 6 & 7 may receive the re-entry request, as described above.

Block 1010 illustrates that, in one embodiment, the BS may retrieve a stored portion of the MS context information to allow the BS to perform a fast handover, as described above. Block 1012 illustrates that, in one embodiment, retrieving may include using a MS context information stored on the BS, as described above. In one embodiment, the MS context information may be stored on the BS due to the results of Block 1002. In one embodiment, the transceiver 202 or controller 204 of FIG. 2, or the BS 406 of FIGS. 5, 6 & 7 may perform the retrieval, as described above.

Block 1014 illustrates that, in one embodiment, retrieving may include determining whether or not a paging controller or a serving BS includes the MS context information, as described above. Block 1016 illustrates that, in one embodiment, determining may include, if a location update timer on the MS has not expired, receiving a serving BS identifier (ID) from the MS, as described above. Block 1018 illustrates that, in one embodiment, determining may include, if a location update timer on the MS has expired, receiving a paging controller ID from the MS, as described above. In one embodiment, the transceiver 202 or controller 204 of FIG. 2, or the BS 406 of FIGS. 5, 6 & 7 may perform the receiving and determining, as described above.

Block 1020 illustrates that, in one embodiment, retrieving may include retrieving the MS context information from the determined paging controller or serving BS, as described above. Block 1022 illustrates that, in one embodiment, retrieving may include receiving a BS identifier (BSID) from the MS, as described above. Block 1024 illustrates that, in one embodiment, retrieving may include 1024 Retrieving the MS context information from the serving BS via a gateway, as described above. In one embodiment, the transceiver 202 of FIG. 2, or the BS 406 of FIGS. 5, 6 & 7 may perform the receiving and retrieving, as described above.

Block 1026 illustrates that, in one embodiment, performing a fast handover may include completing, using the context information, the WiMAX reentry of the MS using an abbreviated handover procedure, as described above. In one embodiment, the base station 201 of FIG. 2, or the BS 406 of FIGS. 5, 6 & 7 may perform the fast handover, as described above.

Block 1028 illustrates that, in one embodiment, the BS may perform the fast handover of the MS from the non-WiMAX network to the WiMAX network, as described above. Block 1030 illustrates that, in one embodiment, performing may include determining which service flows are associated with the MS, as described above. Block 1032 illustrates that, in one embodiment, performing may include de-allocating any or a portion of the previously maintained service flows that are no longer used by the MS, as described above. Block 1032 illustrates that, in one embodiment, performing may include modifying any or a portion of the existing service flows that were modified while the MS was coupled with the non-WiMAX network, as described above. It is understood that a portion of a thing may include some or all of the thing. Block 1034 illustrates that, in one embodiment, performing may include creating equivalent service flows to at least a portion of the service flows that where created when the MS was coupled with the non-WiMAX network. In one embodiment, the base station 201 of FIG. 2, or the BS 406 of FIGS. 5, 6 & 7 may perform the fast handover, as described above.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A method of using a base station (BS) comprising:
receiving, by the BS of a first wireless network, a notification that a mobile station (MS) is entering a semi-idle state with respect to the first network, wherein the semi-idle mode is also associated with the MS performing a handover from a first wireless network based upon a first networking standard to a second wireless network based upon a second networking standard;
storing a portion of a set of context information associated with the MS;
allocating uplink resources for the MS only to receive location update, handover and network reentry request messages from the MS; and
maintaining at least some of the context information of the MS.

2. The method of claim 1 wherein the first wireless network standard includes the WiMAX standard; and
wherein the second wireless network standard includes the WiFi standard.

3. The method of claim 1 wherein the first wireless network includes a wireless signal range of at least one kilometer; and
wherein the second wireless network includes a wireless signal range of less than one kilometer.

4. The method of claim 1 wherein storing a portion of a set of context information includes:
storing quality of service information associated with the MS;
storing security information associated with the MS;
storing MS capability information;
storing service flow information associated with the MS; and
releasing at least some connection identifiers (CIDs) associated with the MS.

5. The method of claim 1 wherein maintaining includes:
using a timer to determine if the MS is still associated with the BS; and
if the MS is no longer associated with the BS, removing the set of MS context information.

6. The method of claim 5 wherein using a timer includes:
receiving a periodic location update from the MS indicating that the MS is still associated with the BS;
resetting a timer, upon receipt of the periodical location update from the MS; and
if the timer expires, determining that the MS is no longer associated with the BS.

7. The method of claim 1 further including:
determining which data paths are associated with the MS;
maintaining the associated data paths between the BS and a gateway (GW); and
wherein a data path includes data routing and tunneling information for MS.

8. The method of claim 7 further including:
if the MS is no longer associated with the BS, de-allocating the associated data paths between the BS and the GW.

9. The method of claim 1 wherein receiving includes receiving a de-registration request that includes an indication that the MS is entering a semi-idle mode.

10. The method of claim 1 further including:
informing a paging controller that the MS is in a semi-idle mode.

11. The method of claim 1 wherein receiving a notification that a mobile station (MS) is entering a semi-idle state includes:
transmitting, by the BS, a deregistration command to the MS that initiates the MS entering the semi-idle state; and
receiving a response, from the MS, that the deregistration command has been received.

12. A method of using a mobile station (MS) comprising:
while the MS is associated with a serving base station (BS) of a network that uses a first wireless networking standard, detecting a target BS of a network that uses the first wireless networking standard;
sending a location update message to the target BS indicating that:
the MS is currently engaged with a network that uses a second wireless networking standard,
the MS is requesting an association between the MS and the target BS, and
the MS is currently in semi-idle mode; and
wherein the location update message indicates that the target BS should retrieve a stored portion of a set of context information to allow the BS to perform a fast handover when a handover is requested by the MS.

13. The method of claim 12 wherein the first wireless network standard includes the WiMAX standard; and
wherein the second wireless network standard includes the WiFi standard.

14. The method of claim 12 wherein the network that uses a first wireless networking standard includes a wireless signal range of at least one kilometer; and
wherein the network that uses a second wireless networking standard includes a wireless signal range of less than one kilometer.

15. The method of claim 12 wherein sending a location update message includes:
sending a purpose indication that indicates that the MS is in a semi-idle mode;
sending a paging controller identifier; and
sending an indication that the MS is currently engaged with a network that uses the second wireless networking standard.

16. The method of claim 12 further including:
determining which of at least one service flow is currently active;
transmitting a service flow management request to the target BS, requesting the establishment of the active service flow(s); and
receiving a service flow management response indicating the success or failure of the service flow management request.

17. The method of claim 12 further including:
periodically transmitting a location update message to the target BS indicating that the MS is still associated with the target BS.

18. The method of claim 12 further including:
transmitting, to the target BS, a request to perform a handover from the network using a second wireless networking standard to the target BS's network using the first wireless networking standard;
modifying at least one currently used service flow between the MS and the target BS; and
disassociating the MS from the network using the second wireless networking standard.

19. The method of claim 18 wherein transmitting a request to perform a handover includes transmitting a ranging request including:
an indication that the MS is attempting re-entry into the target BS's network,
a paging controller identifier (ID) of a paging controller associated with the MS, and
a parameter identifying a handover optimization technique to be used to complete the handover.

20. The method of claim 18 wherein the MS was previously established on the serving BS's network, and was associated with at least one service flow on the serving BS's network; and
wherein establishing at least one currently used service flow includes:
selecting which of the previous service flows are not currently in use,
requesting, from the target BS, that the unused service flow(s) be disassociated with the MS,
determining which, if any, new service flow(s) were established while the MS was engaged with the network that uses a second wireless networking standard and are currently in use, and
requesting, from the target BS, that equivalents to the new service flows be associated with the MS.

21. A method of using a base station (BS) comprising:
receiving, by the base station (BS), a reentry request from a mobile station (MS) indicating that the MS is initiating a handover from a non-WiMAX network back to the WiMAX network;
retrieving a stored portion of the MS context information to allow the BS to perform a fast handover; and
performing the fast handover of the MS from the non-WiMAX network to the WiMAX network.

22. The method of claim 21 wherein retrieving a stored portion of the MS context information includes:
determining if the BS has valid context information for the MS, and if not,
determining whether or not a paging controller or a serving BS includes the MS context information and
retrieving the MS context information from the determined paging controller or serving BS; and
wherein performing a fast handover includes completing, using the context information, the WiMAX reentry of the MS using an abbreviated handover procedure.

23. The method of claim 22 wherein determining includes:
if a location update timer on the MS has not expired, receiving a serving BS identifier (ID) from the MS; and
if a location update timer on the MS has expired, receiving a paging controller ID from the MS.

24. The method of claim 22 wherein retrieving the MS context information from the serving BS includes:
receiving a BS identifier (BSID) from the MS; and
retrieving the MS context information from the serving BS via a gateway.

25. The method of claim 21 wherein performing includes:
determining which service flows are associated with the MS;
de-allocating a portion of the previously maintained service flows that are no longer used by the MS;
modifying a portion of the existing service flows that were modified while the MS was coupled with the non-WiMAX network; and
creating equivalent service flows to at least one service flow that was created while the MS was coupled with the non-WiMAX network.

26. The method of claim 21 wherein the non-WiMAX network includes a WiFi network.

27. The method of claim 21 further including:
receiving, from a MS, a re-entry request message indicating that:
the MS is currently engaged with a non-WiMAX network, and
the MS is requesting an association between the MS and the BS; and
retrieving the MS context information from a paging controller.

28. The method of claim 27 wherein receiving includes receiving a ranging—request from the MS including:
a purpose indication that indicates that the MS is in a semi-idle mode;
a paging controller identifier (ID); and
an indication that the MS is currently connected to a Wireless Local Area Network (WLAN).
